(19) United States
(12) Patent Application Publication
(10) Pub. No.: US 2023/0292202 A1
(43) Pub. Date: Sep. 14, 2023

(54) METHOD AND APPARATUS FOR PERFORMING SLICE-BASED CELL RESELECTION IN NEXT GENERATION MOBILE COMMUNICATION SYSTEM

(71) Applicant: SAMSUNG ELECTRONICS CO., LTD., Suwon-si, Gyeonggi-do (KR)

(72) Inventors: Sangyeob JUNG, Suwon-si (KR); Soenghun KIM, Suwon-si (KR); Anil AGIWAL, Suwon-si (KR); Hyunjeong KANG, Suwon-si (KR)

(21) Appl. No.: 18/040,401

(22) PCT Filed: Aug. 5, 2021
(86) PCT No.: PCT/KR2021/010365

§ 371 Date: Feb. 2, 2023

(30) Foreign Application Priority Data
Aug. 5, 2020 (KR) 10-2020-0098147

(51) Int. Cl. H04W 36/08; H04W 48/18

(52) U.S. Cl. CPC H04W 36/08; H04W 48/18

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. The present invention relates to a method performed by a terminal in a wireless communication system, the method comprising: transmitting, to a base station, a first message including first slice information requested by the terminal; in response to the first message, receiving, from the base station, a second message including second slice information allowed on a network; receiving, from the base station, a third message including third slice information generated based on at least one of the first slice information and the second slice information; and performing a cell reselection based on the third slice information.

### CROSS-REFERENCE TO RELATED APPLICATIONS

This application is a 371 of International Application No. PCT/KR2021/010365 filed on Aug. 5, 2021, which claims priority to Korean Patent Application No. 10-2020-0098147 filed on Aug. 5, 2020, the disclosures of which are herein incorporated by reference in their entirety.

### BACKGROUND

### 1. Field

The disclosure relates to a method and an apparatus for logging and reporting cell measurement information in a next generation mobile communication system. Further, the disclosure relates to a method and an apparatus for reselecting a cell that supports a slice desired by a UE.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

Recently, with the development of the next generation mobile communication system, related researches have been actively performed, and in particular, there is a need for a method and an apparatus for logging and reporting cell measurement information more efficiently. Further, there is a need for a method and an apparatus for reselecting a cell that supports a slice desired by a UE more efficiently.

### SUMMARY

The disclosure is to provide a method for performing a logging and a report of cell measurement information in a next generation mobile communication system.

The disclosure also is to provide a method for reselecting a cell that supports a slice desired by a UE more efficiently in a next generation mobile communication system.

According to an embodiment of the disclosure to solve the above-described problems, a method performed by a terminal in a wireless communication system includes transmitting, to a base station, a first message including first slice information requested by the terminal; in response to the first message, receiving, from the base station, a second message including second slice information allowed on a network; receiving, from the base station, a third message including third slice information generated based on at least one of the first slice information and the second slice information; and performing a cell reselection based on the third slice information.

Further, according to another embodiment of the disclosure to solve the above-described problems, a method performed by a base station in a wireless communication system includes receiving, from a terminal, a first message including first slice information requested by the terminal; in response to the first message, transmitting, to the terminal, a second message including second slice information allowed on a network; and transmitting, to the terminal, a third message including third slice information generated based on at least one of the first slice information and the second slice information, wherein a cell reselection is performed based on the third slice information.

Further, according to still another embodiment of the disclosure to solve the above-described problems, a terminal in a wireless communication system includes a transceiver; and a controller configured to control the transceiver to transmit, to a base station, a first message including first slice information requested by the terminal, control the transceiver to in response to the first message, receive, from the base station, a second message including second slice information allowed on a network, control the transceiver to receive, from the base station, a third message including third slice information generated based on at least one of the first slice information and the second slice information, and perform a cell reselection based on the third slice information.

Further, according to yet still another embodiment of the disclosure to solve the above-described problems, a base station in a wireless communication system includes a transceiver; and a controller configured to: control the transceiver to receive, from a terminal, a first message including first slice information requested by the terminal, control the transceiver to in response to the first message, transmit, to the terminal, a second message including second slice information allowed on a network, and control the transceiver to transmit, to the terminal, a third message including third slice information generated based on at least one of the first slice information and the second slice information, wherein a cell reselection is performed based on the third slice information.

According to an embodiment of the disclosure, it is possible to efficiently perform the logging and the report of the cell measurement information.

Further, according to another embodiment of the disclosure, it is possible to reselect the cell that supports the slice desired by the UE more efficiently.

### BRIEF DESCRIPTION OF THE DRAWINGS

FIG. 1 is a diagram illustrating the structure of an LTE system according to an embodiment of the disclosure.

FIG. 2 is a diagram illustrating a radio protocol structure in an LTE system according to an embodiment of the disclosure.

FIG. 3 is a diagram illustrating the structure of a next generation mobile communication system according to an embodiment of the disclosure.

FIG. 4 is a diagram illustrating a radio protocol structure of a next generation mobile communication system according to an embodiment of the disclosure.

FIG. 5 is a diagram illustrating a technology to log and report cell measurement information according to an embodiment of the disclosure.

FIG. 6 is a flowchart illustrating a UE operation in case that a timer T301 expires or a selected cell is not a suitable cell anymore in an NR system according to an embodiment of the disclosure.

FIG. 7 is a sequential diagram illustrating an operation of an RRC-inactive (RRC_INACTIVE) UE in case that an NR system is unable to comply with configuration information included in an RRC connection resume (RRCResume) message according to an embodiment of the disclosure.

FIG. 8 is a sequential diagram illustrating an operation of a UE that reports corresponding information to a base station and an operation of the base station after the UE performs the embodiment of FIG. 6 or 7 according to an embodiment of the disclosure.

FIG. 9 is a sequential diagram illustrating a process of reselecting a cell that supports a slice desired by a UE in a system in the related art.

FIG. 10 is a sequential diagram illustrating a process of reselecting a cell that supports a slice desired by a UE in a next generation mobile communication system.

FIG. 11 is a sequential diagram illustrating a process of reselecting a cell that supports a slice desired by a UE in a next generation mobile communication system.

FIG. 12 is a sequential diagram illustrating a process of selecting a cell that supports a slice desired by a UE in a next generation mobile communication system.

FIG. 13 is a block diagram illustrating an internal structure of a UE according to an embodiment of the disclosure.

FIG. 14 is a block diagram illustrating the constitution of an NR base station according to an embodiment of the disclosure.

### DETAILED DESCRIPTION

In describing embodiments in the description, explanation of technical contents that are well known in the technical field to which the disclosure pertains and are not directly related to the disclosure will be omitted. This is to transfer the subject matter of the disclosure more clearly without obscuring the same through omission of unnecessary explanations.

For the same reason, in the accompanying drawings, some constituent elements may be exaggerated, omitted, or briefly illustrated. Further, sizes of the respective constituent elements do not completely reflect the actual sizes thereof. In the drawings, the same reference numerals are used for the same or corresponding elements across various figures.

The aspects and features of the disclosure and methods for achieving the aspects and features will be apparent by referring to the embodiments to be described in detail with reference to the accompanying drawings. However, the disclosure is not limited to the embodiments disclosed hereinafter, and it can be implemented in diverse forms. The present embodiments are provided to complete the disclosure and to completely notify those of ordinary skill in the art to which the disclosure pertains of the category of the disclosure, and the disclosure is only defined within the scope of the appended claims. In the entire description of the disclosure, the same reference numerals are used for the same elements across various figures.

In this case, it will be understood that each block of the flowchart illustrations, and combinations of blocks in the flowchart illustrations, can be performed by computer program instructions. These computer program instructions can be provided to a processor of a general purpose computer, special purpose computer, or other programmable data processing apparatus, such that the instructions, which are executed via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable data processing apparatus to produce a computer implemented process such that the instructions that execute on the computer or other programmable data processing apparatus provide steps for implementing the functions specified in the flowchart block or blocks.

Also, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

In this case, the term “˜unit”, as used in an embodiment, means, but is not limited to, a software or hardware component, such as FPGA or ASIC, which performs certain tasks. However, “˜unit” is not meant to be limited to software or hardware. The term “˜unit” may advantageously be configured to reside on the addressable storage medium and configured to execute on one or more processors. Thus, “˜unit” may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and “˜units” may be combined into fewer components and “˜units” or further separated into additional components and “˜units”. Further, the components and “˜units” may be implemented to operate one or more CPUs in a device or a security multimedia card.

Hereinafter, the operation principle of the disclosure will be described in detail with reference to the accompanying drawings. In describing the disclosure hereinafter, detailed explanation of related known functions or configurations will be omitted if it is determined that it obscures the gist of the disclosure in unnecessary detail. Further, terms to be described later are terms defined in consideration of their functions in the disclosure, but may differ depending on intentions of a user or an operator, or customs. Accordingly, they should be defined on the basis of the contents of the whole description of the disclosure.

In describing the disclosure hereunder, a detailed description of a related known function or constitution will be omitted if it is deemed to make the gist of the disclosure unnecessarily vague. Hereinafter, embodiments of the disclosure will be described with reference to the accompanying drawings.

In the following description, a term to identify an access node, a term to denote network entities, a term to denote messages, a term to denote an interface between network entities, and a term to denote a variety of types of identity information have been exemplified for convenience in explanation. Accordingly, the disclosure is not limited to the terms to be described later, and other terms to denote targets having equivalent technical meanings may be used.

For convenience in explanation, in the disclosure, terms and names defined in the 3rd Generation Partnership Project Long Term Evolution (3GPP LTE) standards are used. However, the disclosure is not restricted by the terms and names, and it may be equally applied to systems complying with other standards. In the disclosure, for convenience in explanation, an eNB may be interchangeably used with a gNB. That is, a base station that is explained as an eNB may be represented as a gNB.

### First Embodiment

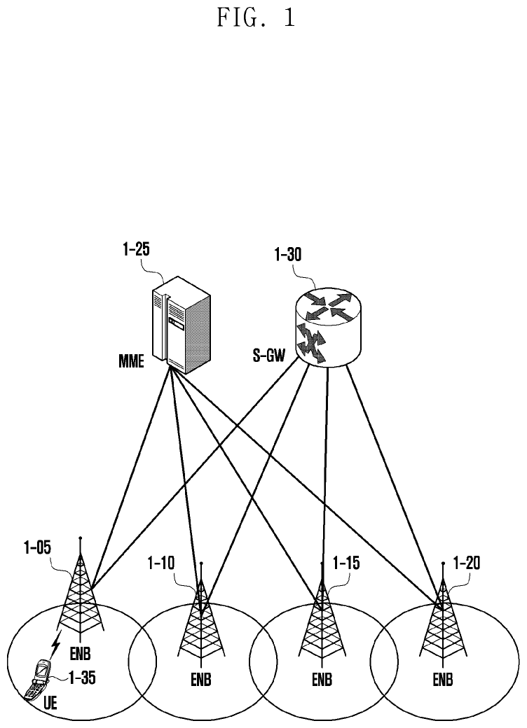

FIG. 1 is a diagram illustrating the structure of an LTE system according to an embodiment of the disclosure.

With reference to FIG. 1, as illustrated, a radio access network of an LTE system is composed of evolved node Bs (hereinafter referred to as “ENBs”, “node Bs”, or “base stations”) 1-05, 1-10, 1-15, and 1-20, a mobility management entity (MME) 1-25, and a serving-gateway (S-GW) 1-30. A user equipment (hereinafter referred to as “UE” or “terminal”) 1-35 accesses an external network through the ENBs 1-05 to 1-20 and the S-GW 1-30.

In FIG. 1, the ENBs 1-05 to 1-20 correspond to existing node Bs of a UMTS system. The ENB is connected to the UE 1-35 on a radio channel, and plays a more complicated role than that of the existing node B. In the LTE system, since all user traffics including a real-time service, such as a voice over IP (VoTP) through an Internet protocol, are serviced on shared channels, entities that perform scheduling through gathering of state information, such as a buffer state, an available transmission power state, and a channel state of UEs, are necessary, and the ENBs 1-05 to 1-20 take charge of this. In general, one ENB controls a plurality of cells. For example, in order to implement a transmission speed of 100 Mbps, the LTE system uses, for example, orthogonal frequency division multiplexing (hereinafter, referred to as “OFDM”) as a radio access technology in a bandwidth of 20 MHz. Further, the LTE system adopts an adaptive modulation & coding (hereinafter, referred to as “AMC”) scheme that determines a modulation scheme and a channel coding rate to match the channel state of the UE. The S-GW 1-30 is an entity that provides a data bearer, and generates or removes the data bearer under the control of the MME 1-25. The MME is an entity that takes charge of not only a mobility management function for the UE but also various kinds of control functions, and is connected to the plurality of base stations.

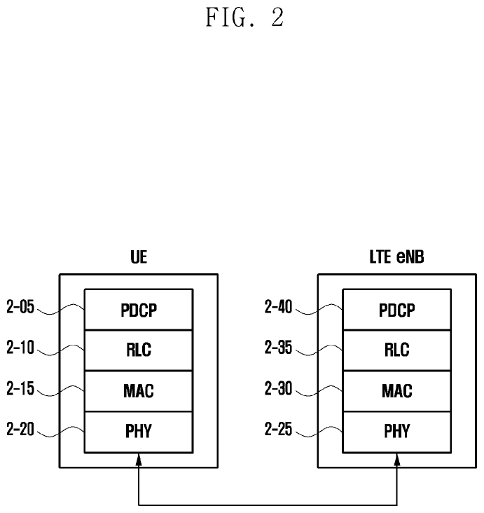

FIG. 2 is a diagram illustrating a radio protocol structure of an LTE system according to an embodiment of the disclosure.

With reference to FIG. 2, in a UE or an ENB, a radio protocol of an LTE system is composed of a packet data convergence protocol (PDCP) 2-05 or 2-40, a radio link control (RLC) 2-10 or 2-35, and a medium access control (MAC) 2-15 or 2-30. The packet data convergence protocol (PDCP) 2-05 or 2-40 takes charge of IP header compression/decompression operations. The main functions of the PDCP are summarized as follows.
Header compression and decompression: ROHC only
Transfer of user data
In-sequence delivery of upper layer PDUs at PDCP re-establishment procedure for RLC AM
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

A radio link control (hereinafter, referred to as “RLC”) 2-10 or 2-35 performs an ARQ operation by reconfiguring a PDCP packet data unit (PDCP PDU) with a suitable size. Main functions of the RLC are summarized as follows.
Transfer of upper layer PDUs
Error correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 is connected to several RLC layer devices constituted in one UE, and performs multiplexing of RLC PDUs into a MAC PDU and demultiplexing of the RLC PDUs from the MAC PDU. The main functions of the MAC are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

A physical layer PHY 2-20 or 2-25 performs channel coding and modulation of upper layer data, and makes and transmits OFDM symbols on a radio channel, or performs demodulation and channel decoding of the OFDM symbols received on the radio channel and transfers the OFDM symbols to an upper layer.

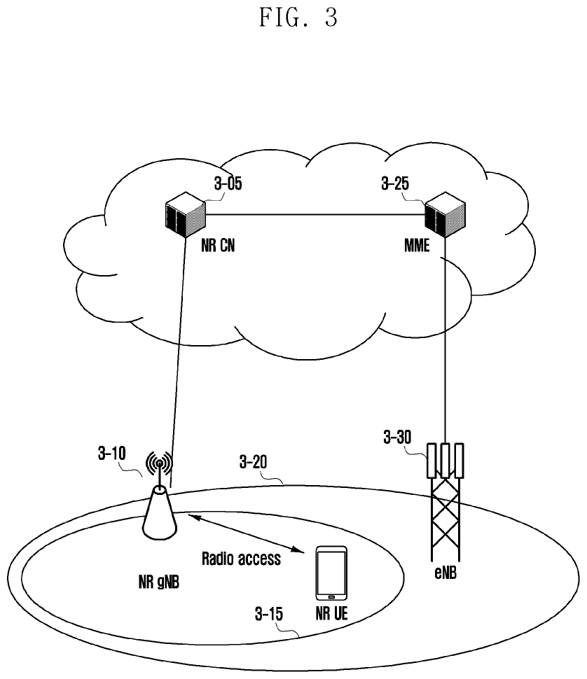

FIG. 3 is a diagram illustrating the structure of a next generation mobile communication system according to an embodiment of the disclosure.

With reference to FIG. 3, as illustrated, a radio access network of a next generation mobile communication system (hereinafter, NR or 5G) is composed of a new radio node B (hereinafter, NR gNB or NR base station) 3-10, and a new radio core network (NR CN) 3-05. A new radio user equipment (hereinafter, NR UE or UE) 3-15 accesses an external network through the NR gNB 3-10 and the NR CN 3-05.

In FIG. 3, the NR gNB 3-10 corresponds to an evolved Node B (eNB) of the existing LTE system. The NR gNB 3-10 is connected to the NR UE 3-15 on a radio channel, and can provide a more superior service than the service of the existing Node B. In the next generation mobile communication system, all user traffics are serviced on shared channels, and thus there is a need for a device that performs scheduling through consolidation of state information, such as a buffer state, an available transmission power state, and a channel state of UEs, and the NR gNB 3-10 takes charge of this. In general, one NR gNB controls a plurality of cells. In order to implement ultrahigh-speed data transmission as compared with that of the existing LTE, a bandwidth that is equal to or higher than the existing maximum bandwidth may be applied, and a beamforming technology may be additionally grafted in consideration of the orthogonal frequency division multiplexing (hereinafter, referred to as “OFDM”) as the radio access technology. Further, the NR gNB 3-10 adopts an adaptive modulation & coding (hereinafter, referred to as “AMC”) scheme that determines the modulation scheme and the channel coding rate to match the channel state of the UE. The NR CN 3-05 performs functions of mobility support, bearer setup, and quality of service (QoS) setup. The NR CN is a device that takes charge of not only a mobility management function for the UE but also various kinds of control functions, and is connected to a plurality of base stations. Further, the next generation mobile communication system may interwork with the existing LTE system, and the NR CN is connected to the MME 3-25 through a network interface. The MME is connected to the eNB 3-30 that is the existing base station.

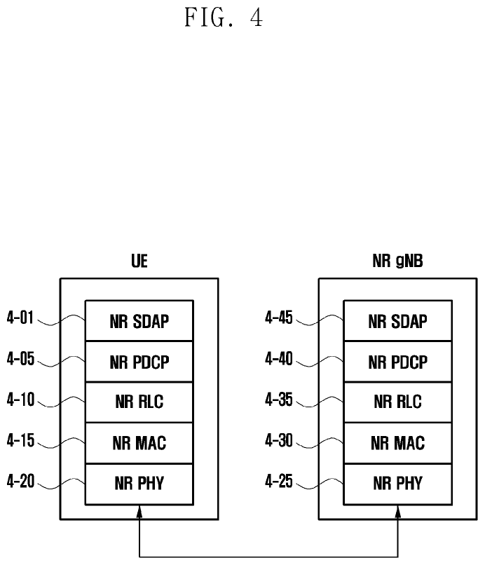

FIG. 4 is a diagram illustrating a radio protocol structure of a next generation mobile communication system according to an embodiment of the disclosure.

With reference to FIG. 4, in the UE or NR base station, the radio protocol of the next generation mobile communication system is composed of an NR service data protocol (SDAP) 4-01 or 4-45, an NR PDCP 4-05 or 4-40, an NR RLC 4-10 or 4-35, and an NR MAC 4-15 or 4-30.

The main functions of the NR SDAP 4-01 or 4-45 may include some of the following functions.
Transfer of user plane data
Mapping between a QoS flow and a DRB for both DL and UL
Marking QoS flow ID in both DL and UL packets
Reflective QoS flow to DRB mapping for the UL SDAP PDUs

With respect to the SDAP layer device, the UE may be configured whether to use a header of the SDAP layer device or whether to use the function of the SDAP layer device for each PDCP layer device, bearer, or logical channel through a radio resource control (RRC) message. If the SDAP header is configured, the UE may indicate that the UE can update or reconfigure mapping information on the uplink and downlink QoS flow and the data bearer through a NAS QoS reflective configuration 1-bit indicator (NAS reflective QoS) and an AS QoS reflective configuration 1-bit indicator (AS reflective QoS) of the SDAP header. The SDAP header may include QoS flow ID information representing the QoS. The QoS information may be used as a data processing priority for supporting a smooth service and scheduling information.

The main functions of the NR PDCP 4-05 or 4-40 may include some of the following functions.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in an uplink

As described above, reordering of the NR PDCP device may mean reordering of PDCP PDUs received from a lower layer based on PDCP sequence numbers (SNs), and may include transferring of data to an upper layer in the order of reordering. Further, the reordering may include immediate transferring of the data without considering the order, recording of lost PDCP PDUs through reordering, reporting of the status for the lost PDCP PDUs to a transmission side, and requesting for retransmission for the lost PDCP PDUs.

The main functions of the NR RLC 4-10 or 4-35 may include some of the following functions.
Transfer of upper layer PDUs
In-sequence delivery of upper layer PDUs
Out-of-sequence delivery of upper layer PDUs
Error correction through an ARQ
Concatenation, segmentation, and reassembly of RLC SDUs
Re-segmentation of RLC data PDUs
Reordering of RLC data PDUs
Duplicate detection
Protocol error detection
RLC SDU discard
RLC reestablishment

As described above, the in-sequence delivery of the NR RLC device may mean the in-sequence delivery of RLC SDUs received from a lower layer to an upper layer, and in case that one original RLC SDU is segmented into several RLC SDUs to be received, the in-sequence delivery of the NR RLC device may include reassembly and delivery of the RLC SDUs and reordering of the received RLC PDUs based on an RLC sequence number (SN) or a PDCP sequence number (SN). The in-sequence delivery of the NR RLC device may include recording of lost RLC PDUs through reordering, status report for the lost RLC PDUs to the transmission side, and retransmission request for the lost RLC PDUs. The in-sequence delivery of the NR RLC device may include in-sequence delivery of only RLC SDUs just before the lost RLC SDU to an upper layer if there is the lost RLC SDU, in-sequence delivery of all RLC SDUs received before a specific timer starts its operation to an upper layer if a specific timer has expired although there is the lost RLC SDU, or in-sequence delivery of all RLC SDUs received up to now to an upper layer if the specific timer has expired although there is the lost RLC SDU. Further, the NR RLC device may process the RLC PDUs in the order of their reception (in the order of arrival, regardless of the order of a serial number or sequence number), and may transfer the processed RLC PDUs to the PDCP device in an out-of-sequence delivery manner, and in case of receiving segments, the NR RLC device may receive the segments stored in a buffer or to be received later, reconfigure and process them as one complete RLC PDU, and then transfer the reconfigured RLC PDU to the PDCP device. The NR RLC layer may not include a concatenation function, and the function may be performed by an NR MAC layer or may be replaced by a multiplexing function of the NR MAC layer.

As described above, the out-of-sequence delivery of the NR RLC device may mean a function of transferring the RLC SDUs received from a lower layer directly to an upper layer regardless of their order, and if one original RLC SDU is segmented into several RLC SDUs to be received, the out-of-sequence delivery of the NR RLC device may include reassembly and delivery of the RLC SDUs. Further, the out-of-sequence delivery of the NR RLC device may include functions of storing and ordering the RLC SNs or PDCP SNs of the received RLC PDUs and recording of the lost RLC PDUs.

The NR MAC 4-15 or 4-30 may be connected to several NR RLC layer devices constituted in one UE, and the main functions of the NR MAC may include some of the following functions.
Mapping between logical channels and transport channels
Multiplexing/demultiplexing of MAC SDUs
Scheduling information reporting
HARQ function (error correction through HARQ)
Priority handling between logical channels of one UE
Priority handling between UEs by means of dynamic scheduling
MBMS service identification
Transport format selection
Padding

The NR PHY layer 4-20 or 4-25 may perform channel coding and modulation of upper layer data to make and transmit OFDM symbols on a radio channel, or may perform demodulation and channel decoding of the OFDM symbols received on the radio channel to transfer the demodulated and channel-decoded symbols to an upper layer.

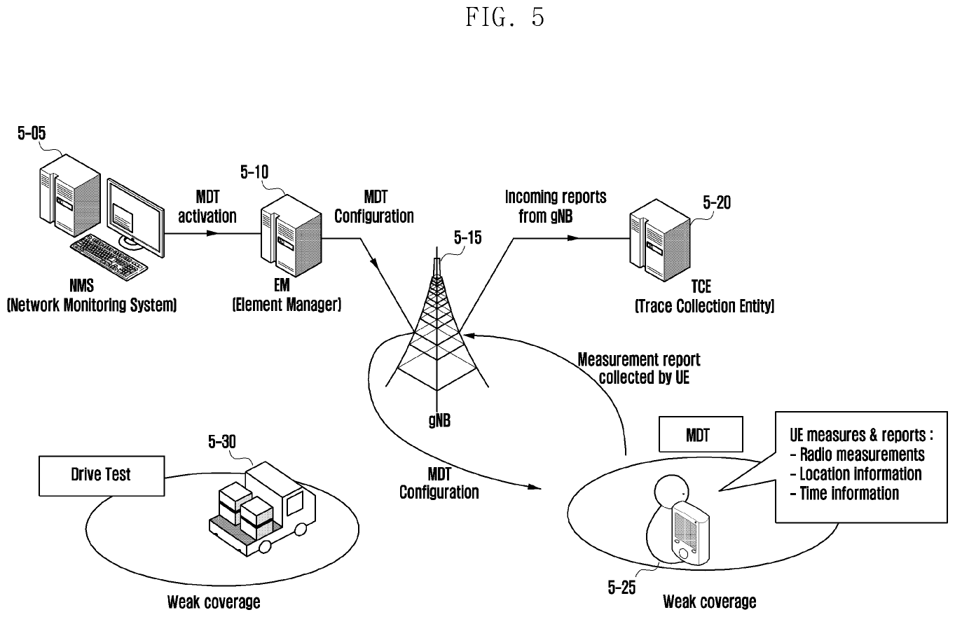

FIG. 5 is a diagram illustrating a technology to log and report cell measurement information according to an embodiment of the disclosure.

During network establishment or optimization, a mobile communication service provider normally measures the signal strength in an expected service area, and based on this, performs a process of arranging or readjusting base stations in the service area. The service provider logs cell measurement information in the service area with signal measurement equipment carried on a vehicle, and this requires lots of time and costs. The above-described process is generally performed by utilizing the vehicle, and thus is generally used as a drive test (5-30). During movement between cells, a UE is mounted with a function capable of measuring a signal to be sent to a base station in order to support operations, such as cell reselection, handover (Ho), or serving cell addition. Accordingly, instead of the drive test, a UE 5-25 in the service area may be utilized, and this is called minimization of drive test (MDT). The service provider may configure an MDT operation to specific UEs through several constituent devices 5-05, 5-10, and 5-15 of the network, and the UEs log and store signal strength information from a serving cell and neighboring cells in an RRC connected mode (RRC_CONNECTED), an RRC idle mode (RRC_IDLE), or an RRC inactive mode (RRC_INACTIVE). In addition, the UEs store various pieces of information, such as location information, time information, and signal quality information. The stored information may be reported to the network 5-15 when the UEs are in the connected mode, and the information is transferred to a specific server 5-20.

The MDT operation is briefly classified into an immediate MDT and a logged MDT.

The immediate MDT is featured to immediately report the logged information to the network. Since the information should be immediately reported, only a UE in the RRC connected mode can perform this. In general, an RRM measurement process for supporting the operations, such as handover and serving cell addition, is reutilized, and location information and time information are additionally reported.

The logged MDT is featured to store the logged information other than immediately report the information and to report the stored information after the UE is switched to the RRC connected mode. In general, the UE in the RRC idle mode or in the RRC inactive mode, which is unable to immediately report the information to the network, performs the logged MDT. In the disclosure, the UE in the RRC inactive mode, which is introduced in the next generation mobile communication system, is featured to perform the logged MDT. The network provides the UE with the configuration information for performing the logged MDT operation when a specific UE is in the RRC connected mode, and the UE logs and stores the configured information after the UE is switched to the RRC idle mode or the RRC inactive mode. The RRC state of the UE that performs the immediate MDT and the logged MDT may be represented as in Table 1 below.

TABLE 1

| | RRC state |
|---|---|
| Immediate MDT | RRC_CONNECTED |
| Logged MDT | RRC_IDLE, RRC_INACTIVE |

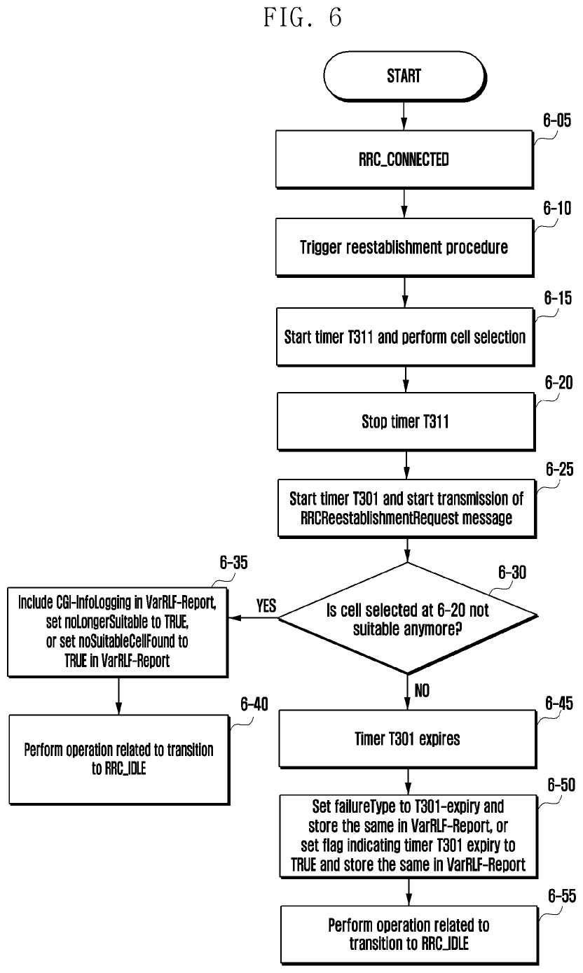

FIG. 6 is a flowchart illustrating a UE operation in case that a timer T301 expires or a selected cell is not a suitable cell anymore in an NR system according to an embodiment of the disclosure.

With reference to FIG. 6, a UE may be in an RRC connected mode (RRC_CONNECTED) by configuring an RRC connection with an NR base station (6-05).

At operation 6-10, The UE in the RRC connected mode may start an RRC connection reestablishment procedure in case that one of the following specific conditions is fulfilled.

Condition:
In case that a radio link failure (hereinafter, RLF) is detected with respect to a master cell group (hereinafter, MCG), and t316 is not set
In case that the RLF is detected in a state where secondary cell group (hereinafter, SCG) transmission is suspended
In case that the RLF is detected with respect to the MCG while primary secondary cell (hereinafter, PSCell) change is ongoing
In case that reconfiguration with sync failure or handover failure (HOF) occurs with respect to the MCG
In case that mobility from NR failure occurs
In case that integrity check failure indication is received from a lower layer device with respect to SRB1 or SRB2 (this case is not applied to an RRCReestablishment message)
In case that an RRC connection reconfiguration failure occurs
In case that the RLF is detected with respect to the SCG in a state where MCG transmission is suspended
In case that the reconfiguration with sync failure or the handover failure (HOF) occurs with respect to the SCG in a state where the MCG transmission is suspended
In case that the SCG change failure occurs in a state where the MCG transmission is suspended
In case that the SCG configuration failure occurs in a state where the MCG transmission is suspended
In case that the integrity check failure indication is received from an SCG lower layer device with respect to SRB3 in a state where the MCG is suspended
In case that timer T316 expires

At operation 6-15, the UE in the RRC connected mode may perform at least the following procedures when starting an RRC connection reestablishment procedure.
The UE may start the timer T311.
The UE may perform a cell selection process in accordance with a cell selection procedure as specified in TS 38.304.

At operation 6-20, the UE may stop the driven timer T311 in case of selecting a suitable NR cell. In accordance with the TS 38.304, definition of the suitable NR cell is as follow.

Suitable Cell:

For UE not operating in SNPN Access Mode, a cell is considered as suitable if the following conditions are fulfilled:
The cell is part of either the selected PLMN or the registered PLMN or PLMN of the Equivalent PLMN list, and for that PLMN either:
The PLMN-ID of that PLMN is broadcast by the cell with no associated CAG-IDs and CAG-only indication in the UE for that PLMN (TS 23.501) is absent or false;
Allowed CAG list in the UE for that PLMN (TS 23.501) includes a CAG-ID broadcast by the cell for that PLMN;
The cell selection criteria are fulfilled, see clause 5.2.3.2.

According to the latest information provided by NAS:
The cell is not barred, see clause 5.3.1;
The cell is part of at least one TA that is not part of the list of “Forbidden Tracking Areas” (TS 22.261), which belongs to a PLMN that fulfills the first bullet above.

For UE operating in SNPN Access Mode, a cell is considered as suitable if the following conditions are fulfilled:
The cell is part of either the selected SNPN or the registered SNPN of the UE;
The cell selection criteria are fulfilled, see clause 5.2.3.2;

According to the latest information provided by NAS:
The cell is not barred, see clause 5.3.1;
The cell is part of at least one TA that is not part of the list of “Forbidden Tracking Areas” which belongs to either the selected SNPN or the registered SNPN of the UE.

At operation 6-25, the UE may start the timer T301, and may start an RRC connection reestablishment request message (RRCReestablishmentRequest) transmission procedure.

At operation 6-30, the UE according to an embodiment of the disclosure may determine whether the suitable NR cell selected at operation 6-20 is not suitable anymore. The operation 6-30 may occur after the suitable NR cell is selected at operation 6-20.

It is proposed to store CGI-Info-Logging information for the suitable NR cell selected at operation 6-35 in VarRLF-Report. The CGI-Info-Logging may be constituted by the following information.
Cell identity included in the first PLMN-IdentityInfo IE of PLMN-IdnetityInfoList being broadcasted over SIB1
PLMN-Identity existing in the first entry in the PLMN-IdentityList being broadcasted over SIB1
Tracking area code mapped onto the above-described Cell Identity being broadcasted over SIB1

CGI-Info-Logging information may be represented as in Table 2 below.

TABLE 2
- CGI-Info-Logging
The IE CGI-Info-Logging indicates the NR Cell Global Identifier (NCGI) for logging purposes (e.g. RLF report), the globally
unique identity, and the TAC information of a cell in NR.

CGI-Info-Logging information element

```
  ASN1START
  TAG CGI INFO LOGGING START
```

| | |
|---|---|
| CGI-Info-Logging-r16 ::= | SEQUENCE { |
| plmn-Identity-r16 | PLMN-Identity, |
| cellIdentity-r16 | CellIdentity, |
| trackingAreaCode-r16 | TrackingAreaCode OPTIONAL |

}
-- TAG-CGI-INFO-LOGGING-STOP
-- ASN1STOP

CGI-Info-Logging field descriptions

cellIdentity
Unambiguously identify a cell within the context of the PLMN. It belongs the first PLMN-IdentityInfo IE of PLMN-IdentityInfoList in
SIB1.
plmn-Identity
Identifies the PLMN of the cell for the reported cellIdentity: the first PLMN entry of plmn-IdentityList (in SIB1) in the instance of
PLMN-IdentityInfoList that contained the reported cellIdentity.
trackingAreaCode
Indicates Tracking Area Code to which the cell indicated by cellIdentity field belongs.

At operation 6-35, the UE according to an embodiment of the disclosure may store CGI-Info-Logging information for the selected suitable NR cell in VarRLF-Report only in case that an RRC connection reestablishment procedure starts due to the radio link failure or handover failure described above at operation 6-10, or may store CGI-Info-Logging information for the selected suitable NR cell in VarRLF-Report only in case that an RRC connection reestablishment procedure starts due to all specific reasons described above at operation 6-10.

At operation 6-35, the UE according to an embodiment of the disclosure may set a flag for noSuitableCellFound to TRUE and may store the flag in the VarRLF-Report. Further, by introducing a new flag (noLongerSuitable), the UE may set a flag for the noLongerSuitable to TRUE, and may store the flag in the VarRLF-Report.

At operation 6-40, the UE may perform the operation related to transition to the RRC idle mode (RRC_IDLE) by setting a release cause to “RRC connection failure”. The above operation may be defined as follows.

The UE shall:
1> reset MAC;
1> set the variable pendingRNA-Update to false, if that is set to true;
1> if going to RRC_IDLE was triggered by reception of the RRCRelease message including a waitTime:
2> if T302 is running:
3> stop timer T302;
2> start timer T302 with the value set to the waitTime;
2> inform upper layers that access barring is applicable for all access categories except categories ‘0’ and ‘2’.
1> else:
2> if T302 is running:
3> stop timer T302;
3> perform the actions as specified in 5.3.14.4;
1> if T390 is running:
2> stop timer T390 for all access categories;
2> perform the actions as specified in 5.3.14.4;
1> if the UE is leaving RRC_INACTIVE:
2> if going to RRC_IDLE was not triggered by reception of the RRCRelease message:
3> if stored, discard the cell reselection priority information provided by the cellReselectionPriorities;
3> stop the timer T320, if running;
1> stop all timers that are running except T302, T320, T325, T330, T331 and T400;
1> discard the UE Inactive AS context, if any;
1> release the suspendConfig, if configured;
1> remove all the entries within VarConditionalReconfig, if any;
1> for each measId, if the associated reportConfig has a reportType set to condTriggerConfig:
2> for the associated reportConfigId:
3> remove the entry with the matching reportConfigId from the reportConfigList within the VarMeasConfig;
2> if the associated measObjectId is only associated to a reportConfig with reportType set to condTriggerConfig:
3> remove the entry with the matching measObjectId from the measObjectList within the VarMeasConfig;
2> remove the entry with the matching measId from the measIdList within the VarMeasConfig;
1> discard the KgNB key, the S-KgNB key, the S-KeNB key, the KRRCenc key, the KRRCint key, the KUPint key and the KUPenc key, if any;
1> release all radio resources, including release of the RLC entity, the BAP entity, the MAC configuration and the associated PDCP entity and SDAP for all established RBs;
1> indicate the release of the RRC connection to upper layers together with the release cause;
1> except if going to RRC_IDLE was triggered by inter-RAT cell reselection while the UE is in RRC_INACTIVE or RRC_IDLE or when selecting an inter-RAT cell while T311 was running:
2> enter RRC_IDLE and perform cell selection as specified in TS 38.304;

At operation 6-45, the timer T301 driven by the UE at operation 6-25 may expire. The reason why the driven timer T301 expires is that the base station does not send a response message to an RRCReestablishmentRequest message transmitted by the UE at operation 6-25 (due to severe overload of the cell), or that the UE has not successfully transmitted the RRCReestablishmentRequest message at operation 6-25. The UE according to an embodiment of the disclosure may store, in the VarRLF-Report, an indicator for indicating that the timer T301 has expired at operation 6-50. The indicator may mean a flag (i.e., a flag for indicating that the timer T301 has expired is set to TRUE and is stored in the VarRLF-Report), or may mean a failureType for indicating that the timer T301 has expired. Further, the time point where the timer T301 expires may be additionally stored in the VarRLF-Report.

At operation 6-55, the UE may perform the operation related to transition to the RRC_IDLE by setting the release cause to “‘RRC connection failure”.

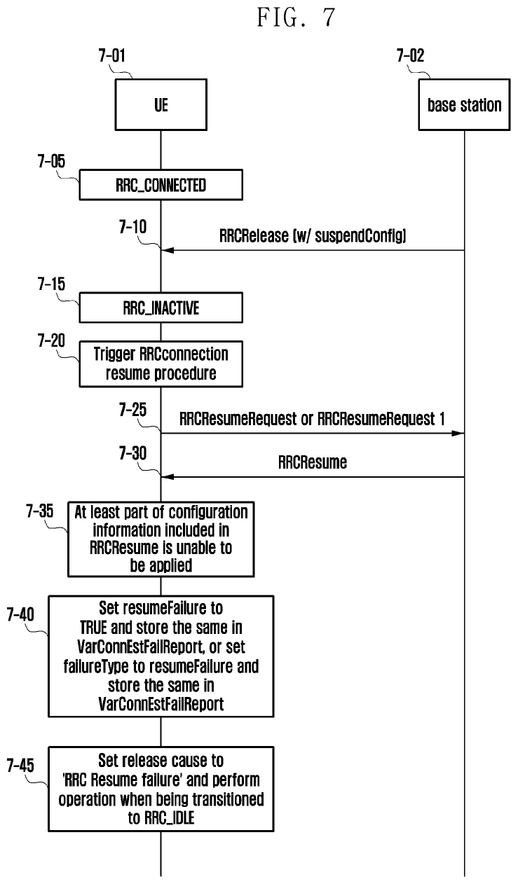

FIG. 7 is a sequential diagram illustrating an operation of an RRC-inactive (RRC_INACTIVE) UE in case that an NR system is unable to comply with configuration information included in an RRC connection resume (RRCResume) message according to an embodiment of the disclosure.

With reference to FIG. 7, a UE 7-01 may configure an RRC connection with an NR base station 7-02, and may be in an RRC connected mode (RRC_CONNECTED) (7-05).

At operation 7-10, the UE may receive an RRC connection release message (RRCRelease) from the NR base station. In the RRC connection release message, suspend configuration information (suspendConfig) that can instruct the UE in the RRC connected mode (RRC_CONNECTED) to be transitioned to the RRC inactive mode (RRC_INACTIVE) may be included.

At operation 7-15, the UE may apply the RRC connection release message including the suspend configuration information, and may be transitioned to the RRC inactive mode.

At operation 7-20, the UE in the RRC inactive mode may start an RRC connection resume procedure for a specific reason. As an example, the UE may be configured by an upper layer device to start the RRC connection resume procedure (e.g., for transmission of mo-Data), or may be configured by an AS layer device to start the RRC connection procedure (e.g., to perform a RAN area update in case of receiving a RAN paging).

At operation 7-25, the UE in the RRC inactive mode may transmit an RRC connection resume request message 1 (RRCResumeRequestl) to the base station in case that useFullResumeID is broadcasted over SIB1. In case that the useFullResumeID is not broadcasted over SIB1, the UE may transmit an RRC connection resume request message (RRCResumeRequest) to the base station.

At operation 7-30, the UE may receive the RRC connection resume message (RRCResume) from the base station.

At operation 7-35, the UE may be unable to comply with at least a part of the configuration information included in the RRC connection resume message (RRCResume) received at operation 7-30 (If the UE is unable to comply with (part of) the configuration included in the RRCResume received over SIB1).

In an embodiment of the disclosure, it is proposed that a new flag for the resumeFailure is introduced in VarConnEstFailReport. That is, at operation 7-40, if the UE is unable to comply with the at least a part of the configuration information included in the RRC connection resume message received at operation 7-30, the UE may set the resumeFailure to TRUE and may store the resumeFailure in the VarConnEstFailReport. Further, an embodiment of the disclosure proposes introduction of a new failureType. That is, at operation 7-40, if the UE is unable to comply with the at least a part of the configuration information included in the RRC connection resume message received at operation 7-30, the UE may set the failureType to resumeFailure and may store the resumeFailure in the VarConnEstFailReport.

At operation 7-45, the UE may perform the operation related to transition to the RRC idle mode (RRC_IDLE) by setting the release cause to “RRC Resume failure”.

The UE according to an embodiment of the disclosure may erase the new flag or failureType for the resumeFailure stored in the VarConnEstFailReport only in case that the plmn-Identity stored in the VarConnEstFailReport does not belong to RPLMN or does not coincide with the RPLMN.

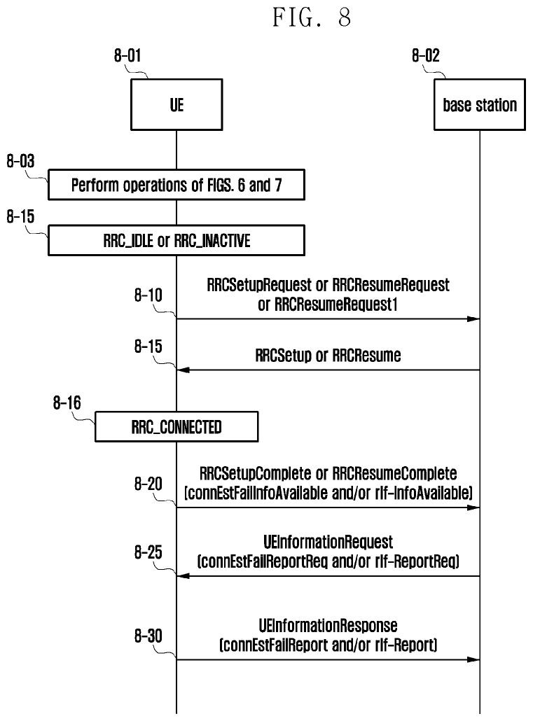

FIG. 8 is a sequential diagram illustrating an operation of a UE that reports corresponding information to a base station and an operation of the base station after the embodiment of FIG. 6 or 7 is performed according to an embodiment of the disclosure.

With reference to FIG. 8, a UE 8-01 may perform the above-described embodiment of FIG. 6 or 7 (8-03).

At operation 8-05, the UE may be in an RRC idle mode (RRC_IDLE) or an RRC inactive mode (RRC_INACTIVE) for a specific reason (8-05).

At operation 8-10, if the UE is in the RRC idle mode at operation 8-05, the UE may transmit an RRC connection setup request message (RRCSetupRequest) to an NR base station 8-02. At operation 8-15, the UE in the RRC idle mode may receive an RRC connection setup message (RRCSetup) from the NR base station. After applying the RRC connection setup message, the UE may be transitioned to the RRC connected mode (8-16). Further, in case that connection establishment/resume failure information is present in VarConnEstFailReport, and plmn-Identity stored in the VarConnEstFailReport coincides with RPLMN, the UE may include connEstFailInfoAvailable in an RRC connection setup complete message (RRCSetupComplete). Further, in case that radio link failure or handover failure information is present in VarRLF-Report, and the RPLMN is included in plmn-IdentityList stored in the VarRLF-Report, the UE may include rlf-InfoAvailable in the RRC connection setup complete message. The corresponding VarRLF-Report may mean an NR VarRLF-Report, an LTE VarRLF-Report, or both the NR VarRLF-Report and the LTE VarRLF-Report. If the VarRLF-Report means both the NR VarRLF-Report and the LTE VarRLF-Report, the UE may perform the above-described operation for each RAT.

At operation 8-10, in case that the UE is in the RRC idle mode at operation 8-05, the UE may transmit the RRC connection setup request message (RRCSetupRequest) to the NR base station. At operation 8-15, the UE in the RRC idle mode may receive the RRC connection setup message (RRCSetup) from the NR base station. After applying the RRC connection setup message, the UE may be transitioned to the RRC connected mode (8-16). Further, in case that the connection establishment/resume failure information is present in the VarConnEstFailReport, and the plmn-Identity stored in the VarConnEstFailReport coincides with the RPLMN, the UE may include the connEstFailInfoAvailable in the RRC connection setup complete message (RRCSetupComplete). Further, in case that the radio link failure or handover failure information is present in the VarRLF-Report, and the RPLMN is included in the plmn-IdentityList stored in the VarRLF-Report, the UE may include the rlf-InfoAvailable in the RRC connection setup complete message. The corresponding VarRLF-Report may mean the NR VarRLF-Report, the LTE VarRLF-Report, or both the NR VarRLF-Report and the LTE VarRLF-Report. If the VarRLF-Report means both the NR VarRLF-Report and the LTE VarRLF-Report, the UE may perform the above-described operation for each RAT.

At operation 8-10, in case that the UE is in the RRC idle mode at operation 8-05, the UE may transmit the RRC connection setup request message (RRCSetupRequest) to the NR base station. At operation 8-15, the UE in the RRC idle mode may receive the RRC connection setup message (RRCSetup) from the NR base station. After applying the RRC connection setup message, the UE may be transitioned to the RRC connected mode (8-16). Further, in case that the connection establishment/resume failure information is present in the VarConnEstFailReport, and the plmn-Identity stored in the VarConnEstFailReport coincides with the RPLMN, the UE may include the connEstFailInfoAvailable in the RRC connection setup complete message (RRCSetupComplete). Further, in case that the radio link failure or handover failure information is present in the VarRLF-Report, and the RPLMN is included in the plmn-IdentityList stored in the VarRLF-Report, the UE may include the rlf-InfoAvaialble in the RRC connection setup complete message. The corresponding VarRLF-Report may mean the NR VarRLF-Report, the LTE VarRLF-Report, or both the NR VarRLF-Report and the LTE VarRLF-Report. If the VarRLF-Report means both the NR VarRLF-Report and the LTE VarRLF-Report, the UE may perform the above-described operation for each RAT.

At operation 8-10, in case that the UE is in the RRC idle mode at operation 8-05, the UE may transmit the RRC connection resume request message (RRCresumeRequest) or the RRC connection resume request 1 message (RRCresumeRequestl) to the NR base station. At operation 8-15, the UE in the RRC idle mode may receive the RRC connection setup message (RRCSetup) from the NR base station. After applying the RRC connection setup message, the UE may be transitioned to the RRC connected mode (8-16). Further, in case that the connection establishment/resume failure information is present in the VarConnEstFailReport, and the plmn-Identity stored in the VarConnEstFailReport coincides with the RPLMN, the UE may include the connEstFailInfoAvailable in the RRC connection setup complete message (RRCSetupComplete). Further, in case that the radio link failure or handover failure information is present in the VarRLF-Report, and the RPLMN is included in the plmn-IdentityList stored in the VarRLF-Report, the UE may include the rlf-InfoAvaialble in the RRC connection setup complete message. The corresponding VarRLF-Report may mean the NR VarRLF-Report, the LTE VarRLF-Report, or both the NR VarRLF-Report and the LTE VarRLF-Report. If the VarRLF-Report means both the NR VarRLF-Report and the LTE VarRLF-Report, the UE may perform the above-described operation for each RAT.

At operation 8-25, the NR base station may transmit a UEInformationRequest message to the UE. In case that a connEstFailInfoAvailable indicator is received at operation 8-20, the NR base station may include a connEstFailReportReq indicator in the UEInformationRequest message. In case that an rlf-InfoAvailable indicator is received at operation 8-20, the NR base station may include an rlf-ReportReq indicator in the UEInformationReugest message.

At operation 8-30, the UE having received the UEInformationRequest message may transmit a UEInformationResponse message to the NR base station. In case that the connEstFailReportReq indicator is set to TRUE and is included in the UEInformationRequest message, the plmn-Identity stored in the VarConnEstFailReport coincides with the RPLMN, and connection establishment failure or connection resume failure information is present in the VarConnEstFailReport, the UE may set the resumeFailure to “TRUE” in the connEstFailReport or may set the failureType to resumeFailureType, and may include the same in the UEInformationResponse message to be transmitted to the base station. In case that the rlf-ReportReq indicator is set to TRUE and is included in the UEInformationRequest message, the plmn-IdentityList stored in the VarRLF-Report coincides with the RPLMN, and radio link failure or handover failure information is present in the VarRLF-Report, the UE may set a flag for CGI-Info-Logging information or noSuitableCellFound to TRUE or may set a flag for noLongerSuitable to TRUE, and may include the same in the UEInformationResponse message to be transmitted to the base station.

At operation 8-30, in case that the NR base station does not support the information proposed in the embodiment of FIG. 6 or 7 (i.e., the corresponding base station supports only R16 version or includes only r16 information element) when the ULE transmits the UEInformationResponse message to the corresponding base station, the ULE may transmit the UEInformationResponse message to the NR base station without including the information proposed in the embodiment of FIG. 6 or 7 therein. Further, at operation 8-25, the NR base station may explicitly request the information proposed in the embodiment of FIG. 6 or 7 from the UE. If the NR base station does not explicitly request the information proposed in the embodiment of FIG. 6 or 7 from the UE, the UE may transmit the UEInformationResponse message to the NR base station without including the information proposed in the embodiment of FIG. 6 or 7 therein.

For convenience in explanation, FIGS. 6, 7, and 8 have been prepared only for an NR system, and the same principle may be applied even to an LTE system.

### Second Embodiment

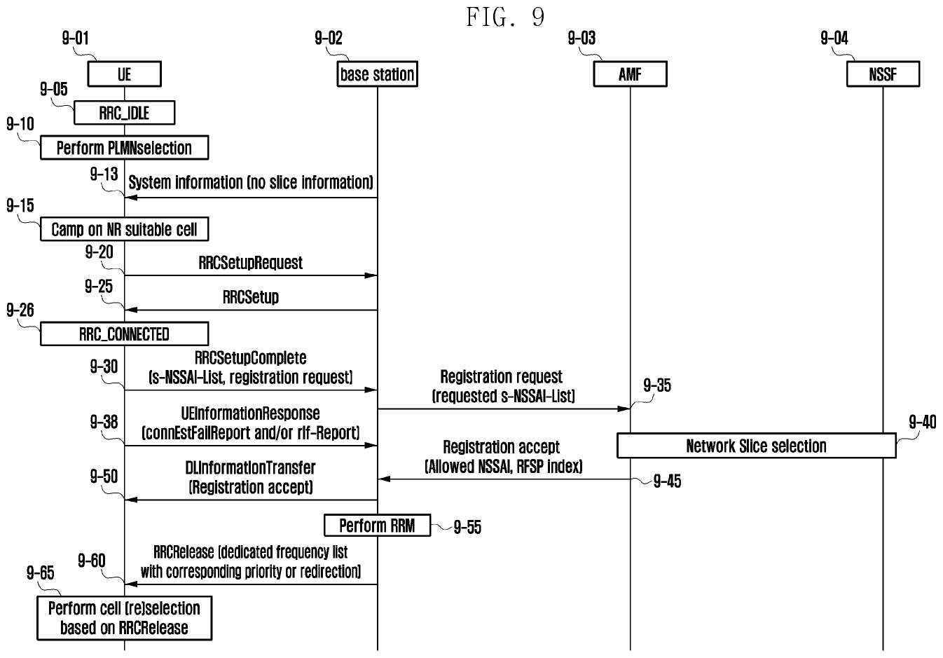

FIG. 9 is a sequential diagram illustrating a process of reselecting a cell that supports a network slice (or slice, hereinafter, interchangeably used with each other) desired by a UE in a system in the related art.

With reference to FIG. 9, a UE 9-01 may be in an RRC idle mode (RRC_IDLE) (9-05).

At operation 9-10, the UE in the RRC idle mode may perform a PLMN selection process.

At operation 9-15, the UE in the RRC idle mode may obtain system information (9-13), and may camp on an NR suitable cell through a cell selection or cell reselection process. In the disclosure, the system information may be featured not to include slice-related information.

The UE in the RRC idle mode may perform an RRC connection establishment procedure with a camp-on cell. At operation 9-20, the UE may transmit an RRC connection establishment request message (RRCSetupRequest) to an NR base station. At operation 9-25, the NR base station may transmit an RRC connection setup message to the UE. The UE having received the RRC connection setup message may apply configuration information included in the RRC connection setup message, and may be transitioned to an RRC connected mode (RRC_CONNECTED) (9-26).

At operation 9-30, the UE having been transitioned to the RRC connected mode may transmit an RRC connection setup complete message to the NR base station. If an upper layer device provides one or plural pieces of single network slice selection assistance information (S-NSSAI), the UE may include S-NSSAI-List in the RRC connection setup complete message with values provided by the upper layer device, and may transmit the RRC connection setup complete message to the NR base station. In addition, the UE may include a registration request message in the RRC connection setup complete message, and may transmit the RRC connection setup complete message to the NR base station. Each S-NSSAI may be composed of a slice/service type (SST) or the SST and slice/service type and slice differentiator (SST-SD), and ASN.1 structure may be represented as in Table 3 below.

TABLE 3
- S-NSSAI
The IE S-NSSAI (Single Network Slice Selection Assistance Information) identifies a Network Slice end to end and comprises a
slice/service type and a slice differentiator, see TS 23.003 [21].

S-NSSAI information element

-- ASN1START
-- TAG-S-NSSAI-START

| | |
|---|---|
| S-NSSAI ::= | CHOICE{ |
| sst | BIT STRING (SIZE (8)), |
| sst -SD | BIT STRING (SIZE (32)) |

-- TAG-S-NSSAI-STOP
ASN1STOP

S-NSSAI field descriptions

sst
Indicates the S-NSSAI consisting of Slice/Service Type, see TS 23.003 [21].
sst-SD
Indicates the S-NSSAI consisting of Slice/Service Type and Slice Differentiator, see TS 23.003 [21].

At operation 9-35, the NR base station may forward the registration request message to an access and mobility management function (AMF) 9-03. Meanwhile, at operation 9-38, the UE having received the UEInformationRequest message may transmit the UEInformationResponse message to the NR base station.

At operation 9-40, a network slice selection function (NSSF) 9-04 may select a supportable network slice in a 5G core, and may transfer the network slice to the AMF.

At operation 9-45, the AMF may include the supportable NSSAI in a registration accept message to be transmitted to the NR base station. In the message, a slice selection priority index value for each frequency/RAT (index to RAT/frequency slice selection priority (hereinafter, RFSP index)) may also be included.

At operation 9-50, the NR base station may transmit a DLInformationTransfer message to the UE. The message may include a registration accept message.

At operation 9-55, the NR base station may perform a radio resource management (RRM) function based on the RFSP index received from the AMF.

At operation 9-60, the NR base station may transmit an RRCRelease message for movement to a cell supported by a slice requested by the UE. The RRCRelease message may include a frequency or a frequency list supported by the slice requested by the UE and a priority value mapped onto the frequency or the frequency list, or may indicate redirection to the frequency or the RAT supported by the slice requested by the UE. In the disclosure, the slice-related information may be featured not to be included in the RRCRelease message or a HO command.

At operation 9-65, the UE may perform the cell selection or cell reselection process based on the information included in the RRCRelease message.

The features for the system in the related art may be defined as follows.
1. The information about the slice is not broadcasted through the system information.
2. The UE does not know whether the s-NSSAI-List requested by the UE is allowed, and performs the RRC connection establishment procedure for the base station.
3. The base station does not include separate slice information in the RRCRelease message, and stores suitable configuration information so as to reselect the cell supported by the slice requested by the UE.
4. The s-NSSAI lists supported for each PLMN are equal to each other.

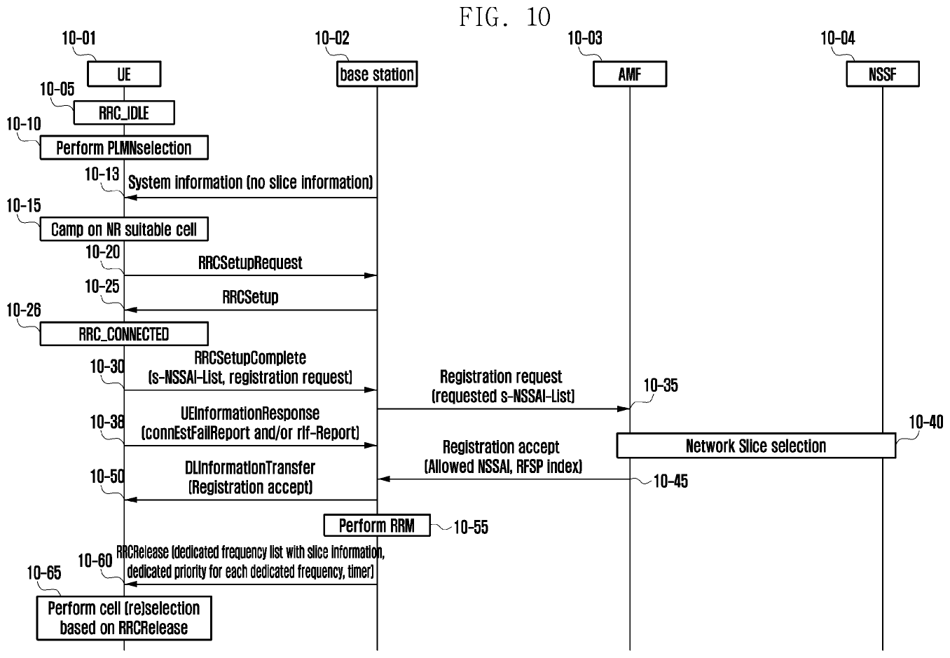

FIG. 10 is a sequential diagram illustrating a process of reselecting a cell that supports a slice desired by a UE in a next generation mobile communication system.

With reference to FIG. 10, operations 10-05 to 10-55 may perform the same procedure as that of the operations 9-05 to 9-55 of FIG. 9 as described above.

At operation 10-60, an NR base station may transmit an RRCRelease message for movement to a cell supported by the S-NSSAI list requested by the UE at operation 10-30.

The disclosure proposes that S-NSSAI information requested by the UE is included in the RRCRelease message. This is because supportable s-NSSAI for each PLMN or for each frequency may differ. Specifically, the NR base station may transmit the RRCRelease message to the UE in accordance with at least one of the following methods.
Method 1: In case that s-NSSAI or s-NSSAI list information being supportable for each frequency is included, or the s_NSSAI or s-NSSAI list that can support a plurality of frequencies is commonly applied, the plurality of frequencies and the s-NSSAI or s-NSSAI list information mapped onto the frequencies are included.
   In this case, an individual frequency and a frequency priority value mapped onto the individual frequency may be included together. If the frequency priority value mapped onto the individual frequency is not included, the UE may configure the highest frequency priority value with respect to the frequency including the s-NSSAI or s-NSSAI list information. For example, they may be as in Table 4 below.

TABLE 4
RRCRelease

| | | |
|---|---|---|
| Frequency 1 | Priority 1 | S-NSSAI 1, S-NSSAI-2 |
| Frequency 2 | Priority 2 | — |
| Frequency 3 | Priority 3 | S-NSSAI 2, S-NSSAI-3 |

Method 2: Supportable frequency or frequency list information for each s-NSSAI is included, or a supportable frequency or frequency list information for each s-NSSAI list is included.
   In this case, the s-NSSAI or the s-NSSAI list mapped onto each frequency or the frequency list and the frequency priority value mapped onto the individual frequency may be included together. If the frequency priority value mapped onto the individual frequency is not included, the UE may configure the highest frequency priority value with respect to the frequency including the s-NSSAI or s-NSSAI list information. For example, they may be as in Table 5 below.

TABLE 5
RRCRelease

| | | |
|---|---|---|
| S-NSSAI 1 | Frequency 1, | Priority 1 for Frequency 1 |
| | Frequency 2 | Priority 2 for Frequency 2 |
| S-NSSAI 2 | Frequency 3 | Priority 3 for Frequency 3 |
| S-NSSAI 3 | Frequency 5 | Priority 4 for Frequency 5 |

Method 3: Supportable s-NSSAI or s-NSSAI list information for each frequency for each PLMN is included, or the s-NSSAI or s-NSSAI list information mapped onto a plurality of frequencies for each PLMN is included.
   In this case, the PLMN mapped onto the s-NSSAI or the s-NSSAI list, the frequency or the frequency list, and the frequency priority value mapped onto the individual frequency may be included together. If the frequency priority value mapped onto the individual frequency is not included, the UE may configure the highest frequency priority value with respect to the frequency including the s-NSSAI or s-NSSAI list information.
Method 4: Supportable frequency or frequency list information for each s-NSSAI for each PLMN is included, or supportable frequency or frequency list information for each s-NSSAI list for each PLMN is included. If the frequency priority value mapped onto the individual frequency is not included, the UE may configure the highest frequency priority value with respect to the frequency including the s-NSSAI or s-NSSAI list information.
   In this case, the PLMN mapped onto the frequency or the frequency list, the s-NSSAI or the s-NSSAI list, and the frequency priority value mapped onto the individual frequency may be included together.

In the above-described method, when the NR base station transmits an RRCRelease message to the UE at operation 10-60, timer T320 or a new timer may be included in the RRCRelease message.

At operation 10-65, the UE in the RRC idle mode or in the RRC inactive mode may perform a cell reselection process based on the information included in the RRCRelease message. For reference, in case that the timer T320 or the new timer is included in the RRCRelease message, the UE may start the corresponding timer, and may perform the cell reselection process by applying the information included in the RRCRelease message through the above-described method only in case that the corresponding timer is driven. Specifically, the UE may perform the cell reselection process based on the frequency priority configuration information included in the RRCRelease message received at operation 10-60. Further, the UE may perform the cell reselection process based on the frequency priority configuration information included in the RRCRelease message with respect to the frequency supporting specific s-NSSAI or specific s-NSSAI list in order to access the cell supporting the specific s-NSSAI or the specific s-NSSAI list. In case that the frequency priority configuration information is not included with respect to the frequency mapped onto the s-NSSAI or the s-NSSAI list in the RRCRelease message received at operation 10-60, the UE may perform the cell reselection process by configuring the highest priority to the corresponding frequency or frequency list. In addition, if the frequency priority configuration information is not included with respect to the frequency or the frequency list mapped onto the s-NSSAI or the s-NSSAI list in the RRCRelease message received at operation 10-60, the UE may perform the cell reselection process in accordance with the frequency priority value that is broadcasted through system information in case that the corresponding frequency or frequency list is broadcasted through the system information.

For reference, if at least one of the above conditions is fulfilled at operation 10-65, slice information and information mapped onto the slice information may be erased at operation 10-65.
In case of being transitioned to a different RRC state
In case that the timer T320 or a new timer expires
In case of selecting the PLMN by a NAS request
In case that inter-RAT cell selection/reselection occurs (In case that the inter-RAT cell selection/reselection occurs in the RRC_IDLE state, the slice information and the information mapped onto the slice information may not be erased)

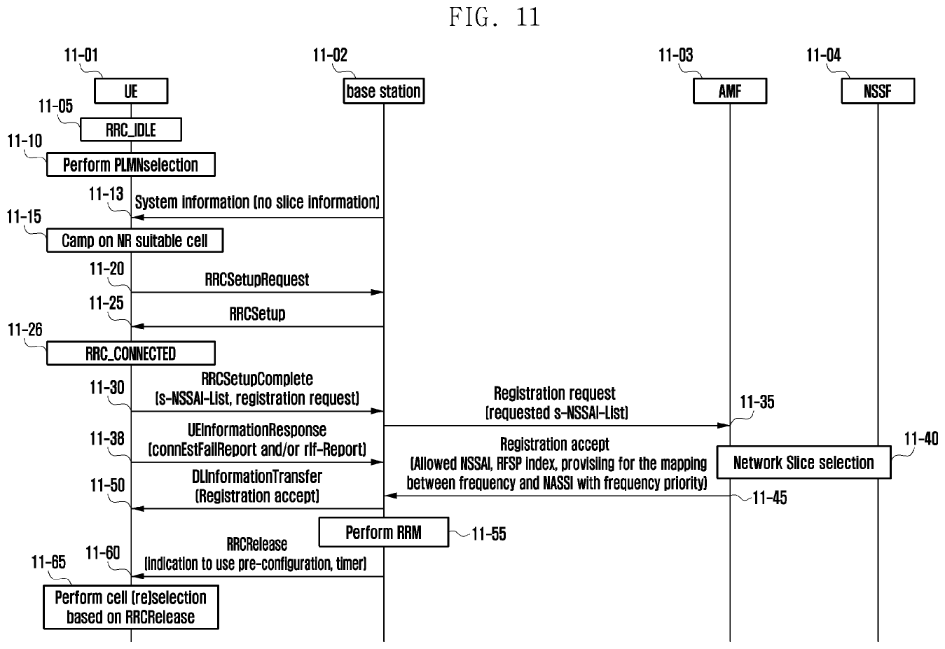

FIG. 11 is a sequential diagram illustrating a process of reselecting a cell that supports a slice desired by a UE in a next generation mobile communication system.

With reference to FIG. 11, operations 11-05 to 11-40 may perform the same procedure as the above-described procedure of FIGS. 9 and 10.

At operation 11-45, an AMF 11-03 may transmit an N2 message to an NR base station. As an example, the N2 message may be registration accept. The N2 message may perform provisioning of each frequency, the frequency priority mapped onto the frequency, and the NSSAI supportable at each frequency.

At operation 11-50, the NR base station may include the N2 message received from the AMF in DLInformationTransfer to be transmitted to the UE.

At operation 11-55, the NR base station may transmit an RRCRelease message to the UE. The RRCRelease message may include an indicator indicating to perform the cell reselection through the information provisioned at operation 11-50. In addition, a timer value (new timer or timer T320) mapped onto the indicator may also be included in the RRCRelease message together.

At operation 11-60, the UE may perform the cell reselection process based on the provisioned information in accordance with the indicator configured at operation 11-55. If the timer value mapped onto the indicator configured at operation 11-55 is included, the UE may perform the cell reselection process based on the provisioned information only during the driving of the timer at operation 11-60. If the timer value mapped onto the indicator configured at operation 11-55 is not included, the UE may perform the cell reselection process based on the provisioned information at operation 11-60.

If at least one of the conditions is fulfilled at operation 11-60, the UE may erase the indicator configured at operation 11-55, and if the timer mapped onto the indicator is being driven, the UE may stop the timer.
In case of being transitioned to a different RRC state
In case that the timer T320 or a new timer expires
In case of selecting the PLMN by a NAS request
In case that inter-RAT cell selection/reselection occurs (In case that the inter-RAT cell selection/reselection occurs in the RRC_IDLE state, the slice information and the information mapped onto the slice information may not be erased)

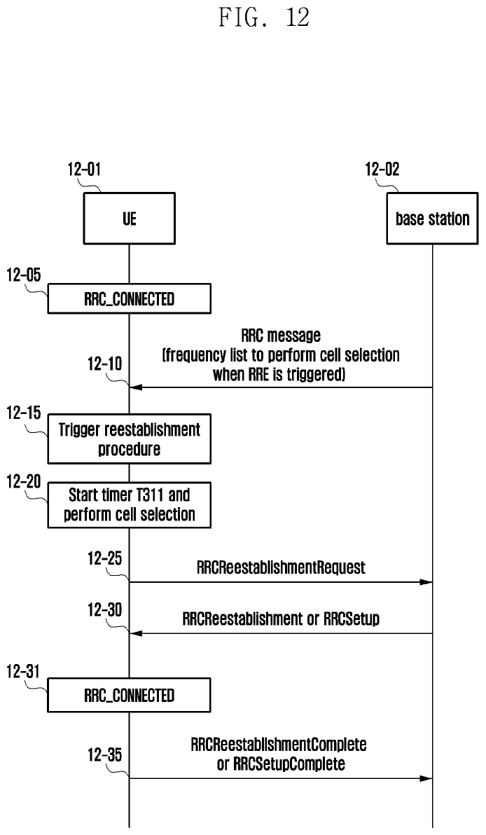

FIG. 12 is a sequential diagram illustrating a process of selecting a cell that supports a slice desired by a UE in a next generation mobile communication system.

With reference to FIG. 12, a UE 12-01 may be in an RRC connected mode by configuring an RRC connection with an NR base station 12-02 (12-05).

At operation 12-10, the UE in the RRC connected mode may receive an RRC message from the NR base station. As an example, the RRC message may mean an RRCReconfiguration message or an RRCResume message. The RRC message may include one or a plurality of frequency lists. The one or the plurality of frequency lists propose to perform a cell selection from the one or the plurality of frequency lists configured in the RRC message when a reestablishment procedure starts. Further, the RRC message may also include S-NSSAI or an S-NSSAI list mapped onto each frequency together. Further, in case that the RRC message represents a HO command, an indicator indicating to perform the cell selection procedure may be included in the frequency indicated in the HO command in case of HO failure.

At operation 12-15, the UE in the RRC connected mode may start the reestablishment procedure for a specific reason. The specific reason may mean at least one of the followings.
In case that a radio link failure (hereinafter, RLF) is detected with respect to a master cell group (hereinafter, MCG), and t316 is not set
In case that the RLF is detected in a state where secondary cell group (hereinafter, SCG) transmission is suspended
In case that the RLF is detected with respect to the MCG while primary secondary cell (hereinafter, PSCell) change is ongoing
In case that reconfiguration with sync failure or handover failure (HOF) occurs with respect to the MCG
In case that mobility from NR failure occurs
In case that integrity check failure indication is received from a lower layer device with respect to SRB1 or SRB2 (this case is not applied to an RRCReestablishment message)
In case that an RRC connection reconfiguration failure occurs
In case that the RLF is detected with respect to the SCG in a state where MCG transmission is suspended
In case that the reconfiguration with sync failure or the handover failure (HOF) occurs with respect to the SCG in a state where the MCG transmission is suspended
In case that the SCG change failure occurs in a state where the MCG transmission is suspended
In case that the SCG configuration failure occurs in a state where the MCG transmission is suspended
In case that the integrity check failure indication is received from an SCG lower layer device with respect to SRB3 in a state where the MCG is suspended
In case that timer T316 expires

At operation 12-20, the UE may start the timer T311 and may perform the cell selection process. The UE may perform the cell selection process in one or a plurality of frequency lists configured in the RRC message at operation 12-10. Further, the UE may perform the cell selection process in consideration of the frequency configured in the RRC message at operation 12-10 and the S-NSSAI or the S-NSSAI list mapped onto the frequency. Specifically, the UE may perform the cell selection process in the frequency in which the corresponding S-NSSAI or S-NSSAI list is supported in consideration of the S-NSSAI or the S-NSSAI list intended to be supported.

At operation 12-25, the UE may transmit an RRCReestablishmentRequest message to the NR base station.

At operation 12-30, the NR base station may transmit an RRCReestablishment message or an RRCSetup message to the UE. The UE may apply the received message, and may be transitioned to the RRC connected mode (12-31).

At operation 12-35, the UE in the RRC connected mode may transmit an RRCRestablishmentComplete message or an RRCSetupComplete message to the NR base station.

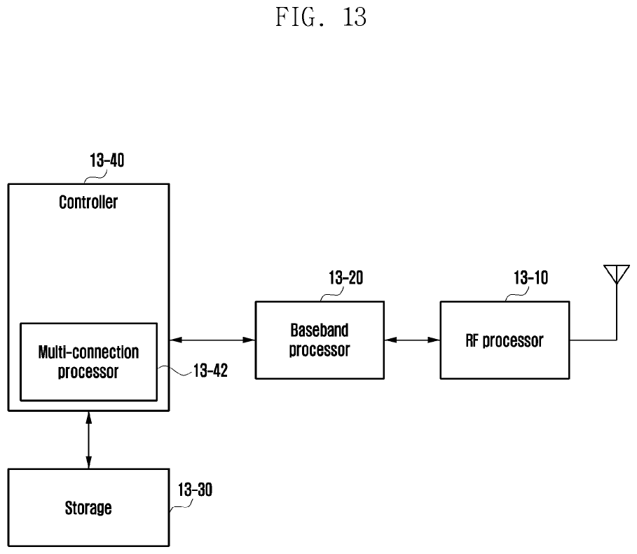

FIG. 13 is a block diagram illustrating the internal structure of a UE according to an embodiment of the disclosure.

With reference to the drawing, the UE includes a radio frequency (RF) processor 13-10, a baseband processor 13-20, a storage unit 13-30, and a controller 13-40.

The RF processor 13-10 performs a function for transmitting and receiving a signal on a radio channel, such as signal band conversion and amplification. That is, the RF processor 13-10 performs up-conversion of a baseband signal provided from the baseband processor 13-20 into an RF-band signal to transmit the converted signal through an antenna, and performs down-conversion of the RF-band signal received through the antenna into a baseband signal. For example, the RF processor 13-10 may include a transmission filter, a reception filter, an amplifier, a mixer, an oscillator, a digital-to-analog converter (DAC), and an analog-to-digital converter (ADC). Although only one antenna is illustrated in the drawing, the UE may be provided with a plurality of antennas. Further, the RF processor 13-10 may include a plurality of RF chains. Further, the RF processor 13-10 may perform beamforming. For the beamforming, the RF processor 13-10 may adjust phases and sizes of signals transmitted or received through the plurality of antennas or antenna elements. Further, the RF processor 13-10 may perform MIMO, and may receive several layers during performing of the MIMO operation.

The baseband processor 13-20 performs a conversion function between a baseband signal and a bit string in accordance with the physical layer standard of the system. For example, during data transmission, the baseband processor 13-20 generates complex symbols by encoding and modulating a transmitted bit string. Further, during data reception, the baseband processor 13-20 restores a received bit string by demodulating and decoding the baseband signal provided from the RF processor 13-10. For example, in case of complying with an orthogonal frequency division multiplexing (OFDM) method, during data transmission, the baseband processor 13-20 generates complex symbols by encoding and modulating a transmitted bit string, performs mapping of the complex symbols onto subcarriers, and then configures OFDM symbols through the inverse fast Fourier transform (IFFT) operation and cyclic prefix (CP) insertion. Further, during data reception, the baseband processor 13-20 divides the baseband signal being provided from the RF processor 13-10 in the unit of OFDM symbols, restores the signals mapped onto the subcarriers through the fast Fourier transform (FFT), and then restores the received bit string through demodulation and decoding.

The baseband processor 13-20 and the RF processor 13-10 transmit and receive the signals as described above. Accordingly, the baseband processor 13-20 and the RF processor 13-10 may be called a transmitter, a receiver, a transceiver, or a communication unit. Further, in order to support different radio access technologies, at least one of the baseband processor 13-20 and the RF processor 13-10 may include a plurality of communication modules. Further, in order to process signals of different frequency bands, at least one of the baseband processor 13-20 and the RF processor 13-10 may include different communication modules. For example, the different radio access technologies may include a wireless LAN (e.g., IEEE 802.11) and a cellular network (e.g., LTE). Further, the different frequency bands may include super high frequency (SHF) (e.g., 2.NR Hz or NR Hz) band and millimeter (mm) wave (e.g., 60 GHz) band.

The storage unit 13-30 stores therein a basic program for an operation of the UE, application programs, and data of configuration information. In particular, the storage unit 13-30 may store information related to a second access node that performs wireless communication by using a second radio access technology. Further, the storage unit 13-30 provides stored data in accordance with a request from the controller 13-40.

The controller 13-40 controls the overall operations of the UE. For example, the controller 13-40 transmits and receives signals through the baseband processor 13-20 and the RF processor 13-10. Further, the controller 13-40 records or reads data in or from the storage unit 13-30. For this, the controller 13-40 may include at least one processor. For example, the controller 13-40 may include a communication processor (CP) that performs a control for communication and an application processor (AP) that controls an upper layer, such as an application program.

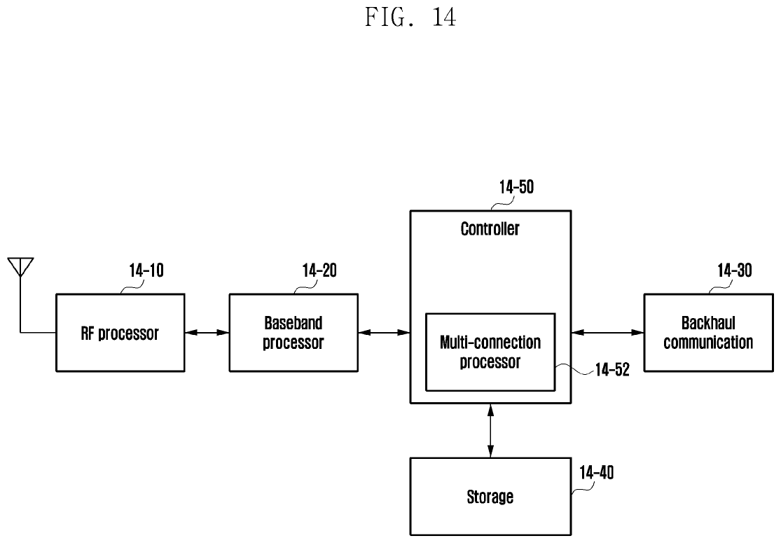

FIG. 14 is a block diagram illustrating the constitution of an NR base station according to an embodiment of the disclosure.

As illustrated in the drawing, the base station is configured to include an RF processor 14-10, a baseband processor 14-20, a backhaul communication unit 14-30, a storage unit 14-40, and a controller 14-50.

The RF processor 14-10 performs a function for transmitting and receiving signals on a radio channel, such as signal band conversion and amplification. That is, the RF processor 14-10 performs up-conversion of a baseband signal provided from the baseband processor 14-20 into an RF-band signal to transmit the converted signal through an antenna, and performs down-conversion of the RF-band signal received through the antenna into a baseband signal. For example, the RF processor 14-10 may include a transmission filter, a reception filter, an amplifier, a mixer, an oscillator, a DAC, and an ADC. Although only one antenna is illustrated in the drawing, the first access node may be provided with a plurality of antennas. Further, the RF processor 14-10 may include a plurality of RF chains. Further, the RF processor 14-10 may perform beamforming. For the beamforming, the RF processor 14-10 may adjust phases and sizes of signals being transmitted or received through the plurality of antennas or antenna elements. The RF processor may perform a downward MIMO operation through transmission of one or more layers.

The baseband processor 14-20 performs a conversion function between a baseband signal and a bit string in accordance with the physical layer standard of the first radio access technology. For example, during data transmission, the baseband processor 14-20 generates complex symbols by encoding and modulating a transmitted bit string. Further, during data reception, the baseband processor 14-20 restores a received bit string by demodulating and decoding the baseband signal provided from the RF processor 14-10. For example, in case of complying with an OFDM method, during data transmission, the baseband processor 14-20 generates complex symbols by encoding and modulating a transmitted bit string, performs mapping of the complex symbols to subcarriers, and then configures OFDM symbols through the IFFT operation and CP insertion. Further, during data reception, the baseband processor 14-20 divides the baseband signal provided from the RF processor 14-10 in the unit of OFDM symbols, restores the signals mapped to the subcarriers through the FFT operation, and then restores the received bit string through demodulation and decoding. The baseband processor 14-20 and the RF processor 14-10 transmit and receive the signals as described above. Accordingly, the baseband processor 14-20 and the RF processor 14-10 may be called a transmitter, a receiver, a transceiver, a communication unit, or a wireless communication unit.

The backhaul communication unit 14-30 provides an interface for performing communication with other nodes in the network. That is, the backhaul communication unit 14-30 converts a bit string being transmitted from the primary base station to other nodes, for example, an auxiliary base station and a core network, into a physical signal, and converts the physical signal being received from other nodes into a bit string.

The storage unit 14-40 stores therein a basic program for an operation of the main base station, application programs, and data of configuration information. In particular, the storage unit 14-40 may store information about a bearer allocated to the connected UE and the measurement result reported from the connected UE. Further, the storage unit 14-40 may store information that becomes the basis of determination of whether to provide or suspend a multi-connection to the UE. Further, the storage unit 14-40 provides stored data in accordance with a request from the controller 14-50.

The controller 14-50 controls the overall operation of the primary base station. For example, the controller 14-50 transmits and receives signals through the baseband processor 14-20 and the RF processor 14-10 or through the backhaul communication unit 14-30. Further, the controller 14-50 records or reads data in or from the storage unit 14-40. For this, the controller 14-50 may include at least one processor.

The embodiments of the disclosure disclosed in the specification and drawings are merely to present specific examples in order to facilitate the explanation of the contents of the disclosure and to help understanding of the disclosure, but are not intended to limit the scope of the disclosure. It is apparent to those of ordinary skill in the art to which the disclosure pertains that other modified examples based on the technical idea of the disclosure can be embodied in addition to the embodiments disclosed herein.

1. A method performed by a terminal in a wireless communication system, the method comprising:
transmitting, to a base station, a first message including first slice information requested by the terminal;
in response to the first message, receiving, from the base station, a second message including second slice information allowed on a network;
receiving, from the base station, a third message including third slice information generated based on at least one of the first slice information and the second slice information; and
performing a cell reselection based on the third slice information.

2. The method of claim 1, wherein the third slice information includes at least one piece of single-network slice selection assistance information (S-NSSAI), at least one piece of frequency information corresponding to the at least one piece of S-NSSAI, and priority information corresponding to the at least one piece of frequency information.

3. The method of claim 1, wherein the third slice information includes at least one piece of single-network slice selection assistance information (S-NSSAI), at least one piece of frequency information corresponding to each list composed of the at least one piece of S-NSSAI, and priority information corresponding to the at least one piece of frequency information.

4. The method of claim 1, wherein the third message further includes information on a timer related to the third slice information, and
wherein the cell reselection is performed based on the third slice information while the timer is running and is performed based on system information in case that the timer expires.

5. A method performed by a base station in a wireless communication system, the method comprising:
receiving, from a terminal, a first message including first slice information requested by the terminal;
in response to the first message, transmitting, to the terminal, a second message including second slice information allowed on a network; and
transmitting, to the terminal, a third message including third slice information generated based on at least one of the first slice information and the second slice information,
wherein a cell reselection is performed based on the third slice information.

6. The method of claim 5, the third slice information includes at least one piece of single-network slice selection assistance information (S-NSSAI), at least one piece of frequency information corresponding to the at least one piece of S-NSSAI or corresponding to each list composed of the at least one piece of S-NSSAI, and priority information corresponding to the at least one piece of frequency information.

7. The method of claim 6, wherein the third message further includes information on a timer related to the third slice information, and
wherein the cell reselection is performed based on the third slice information while the timer is running and is performed based on system information in case that the timer expires.

8. A terminal in a wireless communication system, the terminal comprising:
a transceiver; and
a controller configured to: control the transceiver to transmit, to a base station, a first message including first slice information requested by the terminal, control the transceiver to in response to the first message, receive, from the base station, a second message including second slice information allowed on a network, control the transceiver to receive, from the base station, a third message including third slice information generated based on at least one of the first slice information and the second slice information, and perform a cell reselection based on the third slice information.

9. The terminal of claim 8, wherein the third slice information includes at least one piece of single-network slice selection assistance information (S-NSSAI), at least one piece of frequency information corresponding to the at least one piece of S-NSSAI, and priority information corresponding to the at least one piece of frequency information.

10. The terminal of claim 8, wherein the third slice information includes at least one piece of single-network slice selection assistance information (S-NSSAI), at least one piece of frequency information corresponding to each list composed of the at least one piece of S-NSSAI, and priority information corresponding to the at least one piece of frequency information.

11. The terminal of claim 8, wherein the third message further includes information on a timer related to the third slice information, and
wherein the cell reselection is performed based on the third slice information while the timer is running and is performed based on system information in case that the timer expires.

12. A base station in a wireless communication system, the base station comprising:
a transceiver; and
a controller configured to: control the transceiver to receive, from a terminal, a first message including first slice information requested by the terminal, control the transceiver to in response to the first message, transmit, to the terminal, a second message including second slice information allowed on a network, and control the transceiver to transmit, to the terminal, a third message including third slice information generated based on at least one of the first slice information and the second slice information,
wherein a cell reselection is performed based on the third slice information.

13. The base station of claim 12, wherein the third slice information includes at least one piece of single-network slice selection assistance information (S-NSSAI), at least one piece of frequency information corresponding to the at least one piece of S-NSSAI, and priority information corresponding to the at least one piece of frequency information.

14. The base station of claim 12, wherein the third slice information includes at least one piece of single-network slice selection assistance information (S-NSSAI), at least one piece of frequency information corresponding to each list composed of the at least one piece of S-NSSAI, and priority information corresponding to the at least one piece of frequency information.

15. The base station of claim 12, wherein the third message further includes information on a timer related to the third slice information, and
wherein the cell reselection is performed based on the third slice information while the timer is running and is performed based on system information in case that the timer expires.
